(19) United States
(12) Patent Application Publication
(10) Pub. No.: US 2003/0185431 A1
(43) Pub. Date: Oct. 2, 2003

(54) Method and system for golden template image extraction

(76) Inventors: DeZhong Hong, Singapore (SG); Chiat Pin Tay, Singapore (SG)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/371,326

(22) Filed: Feb. 20, 2003

Related U.S. Application Data
(60) Provisional application No. 60/368,879, filed on Mar. 29, 2002.

(51) Int. Cl. G06K 9/00

(52) U.S. Cl. 382/147

(57) ABSTRACT

A method and system are disclosed for extracting a golden template image of a unit. An image associated with the unit is obtained. A region within the image is selected. A first region growing algorithm extracts an object region using the selected region. A boundary tracing algorithm extracts an outer boundary of the object region using the extracted object region. A second region growing algorithm extracts a golden template image of the unit using the extracted object region.

### RELATED APPLICATIONS

This application claims priority to U.S. Provisional Application No. 60/368,879, entitled “SEMICONDUCTOR INSPECTION SYSTEM AND METHOD,” filed on Mar. 29, 2002. This application is also related to U.S. patent application No. ______, entitled “METHOD AND SYSTEM FOR IMAGE REGISTRATION BASED ON HIERARCHICAL OBJECT MODELING,” filed on ______, which is hereby incorporated herein by reference and commonly owned by the same assignee of this application.

### FIELD

This invention relates generally to computer vision inspection systems for inspecting devices such as, for example, integrated circuit (IC) and printed circuit board (PCB) devices, and, more particularly, to a method and system for golden template image extraction.

### BACKGROUND

Golden template comparison is a common technique for vision inspection systems to detect flaws and defects in images of devices such as IC devices and PCB devices using a golden template image. For instance, features in test images of the devices can be compared with features in the golden template image to determine flaws and defects. The golden template image can thus provide an ideal reference image for a device being inspected, for example, indicating ideal physical features of the device such as the ideal size for “contact leads” or “product markings” for the device.

In prior systems, features for the golden template image were obtained from an image of a “sample golden unit.” The sample golden unit represents an ideal device having minimal flaws or defects. One disadvantage of these systems is that it is difficult to find a good sample golden unit with minimal flaws or defects for obtaining the golden template image. In addition, when performing the golden template image extraction process, the prior systems do not deal with noise, distortion, or other defects in the sample golden unit image introduced by cameras (or CCD cameras) that obtain the sample golden unit image. Furthermore, when all features of the sample golden unit are not of interest, a user may be required to input properties for each feature of interest, which is an inefficient manner of generating the golden template image.

There exists, therefore, a need for an improved golden template image extraction method and system, which can overcome the above disadvantages of prior systems.

### SUMMARY

According to one aspect of the invention, a method is disclosed for extracting a golden template image of a unit. An image associated with the unit is obtained. A region within the image is selected. A first region growing algorithm extracts an object region using the selected region. A boundary tracing algorithm extracts an outer boundary of the object region using the extracted object region. A second region growing algorithm extracts a golden template image of the unit using extracted object region and outer boundary.

According to another aspect of the invention, an image processing system extracts a golden template image of a unit. The image processing system comprises a processor coupled to an imaging device. The imaging device obtains an image associated with the unit. The processor extracts an object region and outer boundary of the object region from the image, and extracts a golden template image using the extracted object region and outer boundary that accommodates for defects in the obtained image.

Other features and advantages will be apparent from the accompanying drawings, and from the detailed description, which follows below.

### BRIEF DESCRIPTION OF THE DRAWINGS

The accompanying drawings, which are incorporated in, and constitute a part of this specification illustrate exemplary embodiments and implementations and, together with the description, serve to explain the principles of the invention. In the drawings,

FIG. 1 illustrates an exemplary block diagram of an image processing system according to an embodiment of the present invention;

FIG. 2 illustrates a flow diagram of a method according to an embodiment of the present invention for processing an image of a sample unit;

FIG. 3 illustrates a flow diagram for extracting a golden template image from an image of a sample unit;

FIG. 4 illustrates a flow diagram of a method for applying a region growing algorithm to extract an object region;

FIG. 5 illustrates a detailed flow diagram of a method for applying a boundary tracing algorithm to extract an outer boundary of an object region;

FIG. 6 illustrates a detailed flow diagram of a method for applying a region growing algorithm using an extracted object region and outer boundary to extract a golden template image;

FIG. 7 illustrates a flow diagram of a method for computing rotational template images of an extracted golden template image;

FIG. 8 illustrates an exemplary image of a unit for extracting a golden template image;

FIG. 9 illustrates an exemplary registration image with an extracted object region;

FIG. 10 illustrates an exemplary boundary tracing graph;

FIG. 11 illustrates an exemplary template registration image with an extracted golden template image of the object; and

FIG. 12 illustrates an exemplary template registration image with a rotated template image.

### DETAILED DESCRIPTION

Reference will now be made in detail to embodiments and implementations, examples of which are illustrated in the accompanying drawings. Wherever possible, the same reference numbers will be used throughout the drawings to refer to the same or like parts.

A. Overview

In accordance with embodiments of the present invention, the following image processing techniques provide a simple way of extracting a golden template image from an image of a sample unit, where the sample unit is a non-golden sample unit having flaws or defects, or, alternatively, where the sample unit is a golden sample unit having minimal flaws or defects. The image processing techniques can accommodate for undesirable flaws and defects in the image of the sample unit. For example, image defects introduced by dust on a lens of an imaging device, such as a charge coupled device (CCD) camera, can be ignored for extracting the golden template image. An automated, object-based, golden template image extracting process in which a user can specify properties and tolerance levels for extracting features and objects from the image of the sample unit is also provided, resulting in minimal user input to extract the golden template image.

In one implementation, an image associated with the sample unit is obtained. A region within the image is selected. A first region growing algorithm extracts an object region using the selected region. A boundary tracing algorithm extracts an outer boundary of the object region using the extracted object region. A second region growing algorithm extracts a golden template image of the sample unit using the extracted object region and outer boundary.

Furthermore, after the golden template image is extracted, an array of rotational template images can be generated for the extracted golden template image. For instance, features from test images of devices or units that have rotated during inspection can be compared with features from corresponding rotational template images to detect flaws and defects on rotated devices or units. The rotational template images can be generated using techniques described below.

The region growing algorithm includes a process of extracting pixels from a particular region of an image of a sample unit for incorporation into a golden template image. The process examines pixels around a selected pixel (e.g., a seed pixel) within the image in a accordance with a specified criteria to determine if the pixels are to be extracted. For example, based on a specified criteria, a neighboring pixel can be determined and identified as a “region pixel” or a “non-region pixel.” This process continues for pixels that have not been examined or identified within a given region. The pixels classified as a “region pixel” can be added to a region (e.g., an object region) in the golden template image. In this manner, a golden template image is extracted from the image of the sample unit.

Furthermore, in the following description, a golden template image refers to an ideal reference image for a device or unit being inspected. It provides a map of object features derived from an image of a sample unit, which can be a non-golden sample unit or a golden sample unit. The object features can include color features, texture features, shape features, and other like features for objects on the unit, or for the unit itself. Each object in the image of the sample unit can have an associated template image. Additionally, the following techniques allow a golden template image to be extracted that can ignore flaws and defects in the image of the sample unit, as described in further detail below.

B. Image System Overview

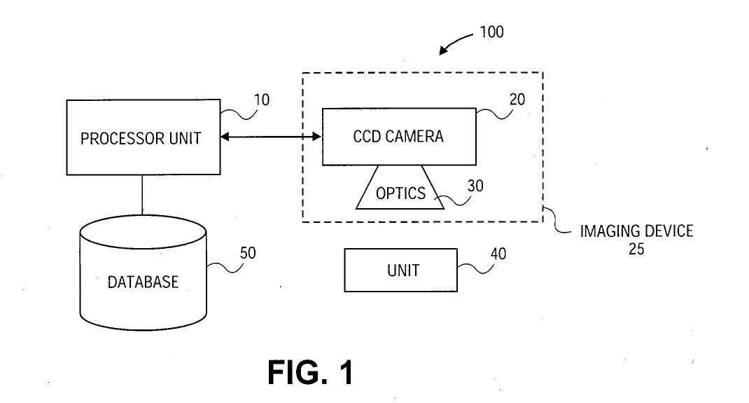

FIG. 1 illustrates an exemplary block diagram of an image processing system 100 constructed according to an embodiment of the present invention. The image processing system 100 includes a processor 10 coupled to an imaging device 25. In this example, imaging device 25 includes a CCD camera 20 having optics 30 for obtaining images of a unit 40. Alternatively, other types of imaging devices or frame grabbers can be used for obtaining images of unit 40. Optics 30 can include CCD camera components or any number of optical components that includes one or more lenses to obtain an image from unit 40.

The obtained image can be converted into a binary bit map for image processing. The converted image can be represented as a raw image or a gray scale image having intensity levels ranging from 0 to 255. The converted image can also be a “registration image.” The registration image is an image with designated object regions that can have an associated identifier (ID). The registration image can include a hierarchical object tree associated with the object regions.

Coupled to processor 10 is a database storage 50 for storing one or more golden template images and the features of devices or units. Other image data, e.g., test images of inspected devices or units and their features, can also be stored in storage 50. Examples of storage 50 include a hard disk drive, a digital video drive, an analog tape drive, random access memory (RAM) devices, flash memory devices, or other like memory devices. Golden template images or other image data can also be stored in remote storage devices connected to processor 10 via a network (not shown). Processor 10 can be implemented within a general purpose computing device such as, for example, a workstation for processing images of unit 40 obtained by CCD camera 20 via optics 30. Processor 10 can perform the techniques disclosed herein using any number of devices including memory devices and central processing units (CPUs).

Additionally, other components (not shown) can be coupled with processor 10 such as a display device and a keyboard input device for performing golden template image extraction. Unit 40 can be a sample unit in which CCD camera 20 and optics 30 obtain an image of unit 40 for extracting a golden template image. Alternatively, unit 40 can be a device or unit for inspection in which features from an image of unit 40 are compared with features from a golden template image stored in storage 50 for detecting flaws and defects on unit 40.

C. Golden Template Image Extraction Techniques

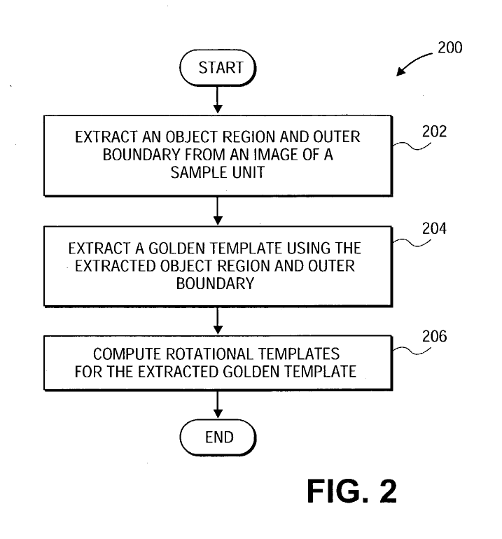

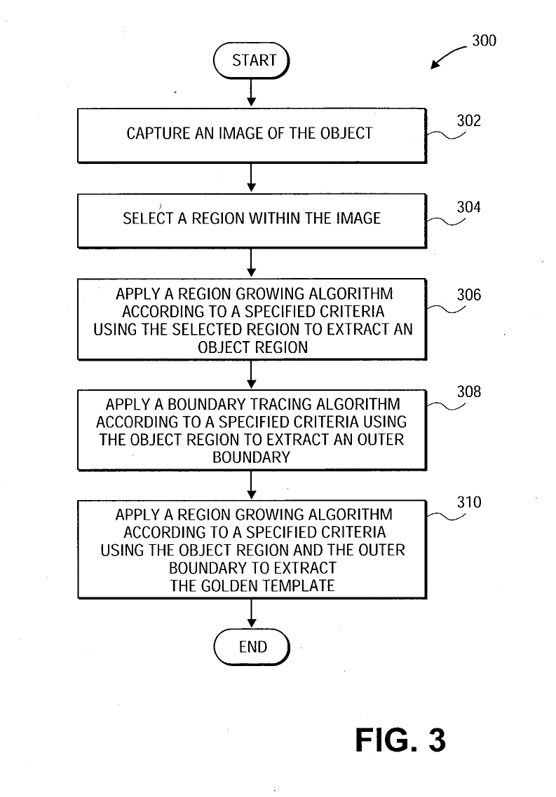

FIG. 2 illustrates a flow diagram of a method 200 for processing an image of a sample unit according to an embodiment of the present invention. Prior to implementing method 200, an image of a sample unit is obtained for image processing. The sample unit can be a non-golden sample unit, or, alternatively, a golden sample unit. From the image of the sample unit, an object region and an outer boundary of the object region are extracted (step 202). The object region and outer boundary can be extracted using respective region growing and outer boundary tracing algorithms according to specified criterias, as described in further detail below regarding FIGS. 3-5.

These algorithms can determine if a pixel in the image of the sample unit should be included as pixels for an object region or outer boundary in the golden template image. In this manner, an object region and outer boundary are extracted from the image of the sample unit for the golden template image. In one implementation, a user inputs a specified criteria to determine the pixels for extraction. The specified criteria can be based on knowledge about the sample unit even if the image of the sample unit contains flaws or defects, e.g., holes in the image, as described in further detail below. The extracted object region and outer boundary can be identified and labeled with an identifier ID. The identified object region and outer boundary can be mapped into a registration image. The following techniques can also be applied to a registration image to extract a golden template image.

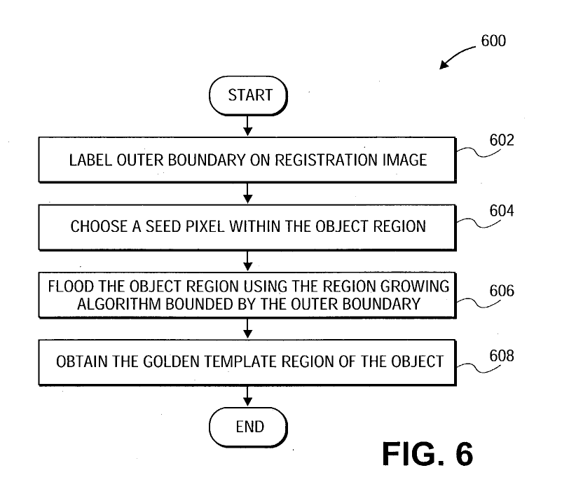

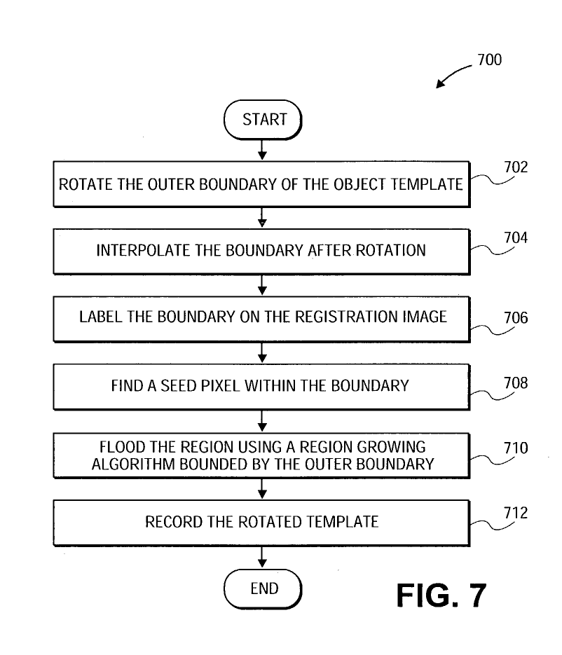

From the extracted object region and outer boundary, a golden template image is extracted (step 204). The golden template image can be extracted using a region growing algorithm according to a specified criteria as described in further detail regarding FIG. 6. This algorithm can ignore flaws such as holes in the image by labeling the pixels in the holes as region pixels if the holes fall within the outer boundary of the object region. In this manner, the hole pixels are filled in for object regions in the golden template image. Because devices or units can be rotated during inspection, an array of rotational template images are computed or generated (step 206). The rotational template images can be generated using an algorithm as described in further detail below regarding FIG. 7. Thus, test images of devices or units that have rotated during inspection can be compared with the rotational template images to detect flaws and defects on such rotated devices or units.

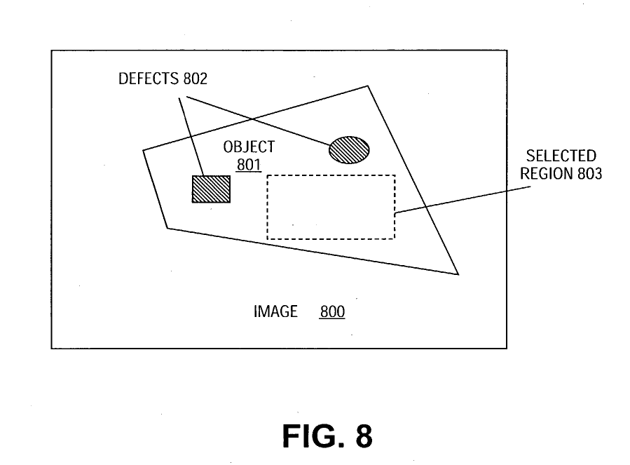

FIG. 3 illustrates a detailed flow diagram of a method 300 for extracting a golden template image from an image of a sample unit. Initially, an image of the sample unit is obtained (step 302 ). For example, CCD camera 20 and optics 30 can obtain an image 800 of the sample unit as shown in FIG. 8. In the example of FIG. 8, image 800 of the sample unit is represented by object 801. The region in image 800 showing object 801 can be used to extract object 801 for incorporation into a golden template image. This image region can also possess certain features including color features, texture features, edge features, and other like features. These features can define object 801 and be expressed by a feature vector V={f₁, f₂, . . . , fₘ}. There can be a total of m features in the feature vector, wherein, e.g., feature vector f₁ may represent a color feature vector, feature vector f₂ may represent a texture feature vector, and feature vector f₃ may represent an edge feature vector, and so on for an object on the unit, or for the unit itself.

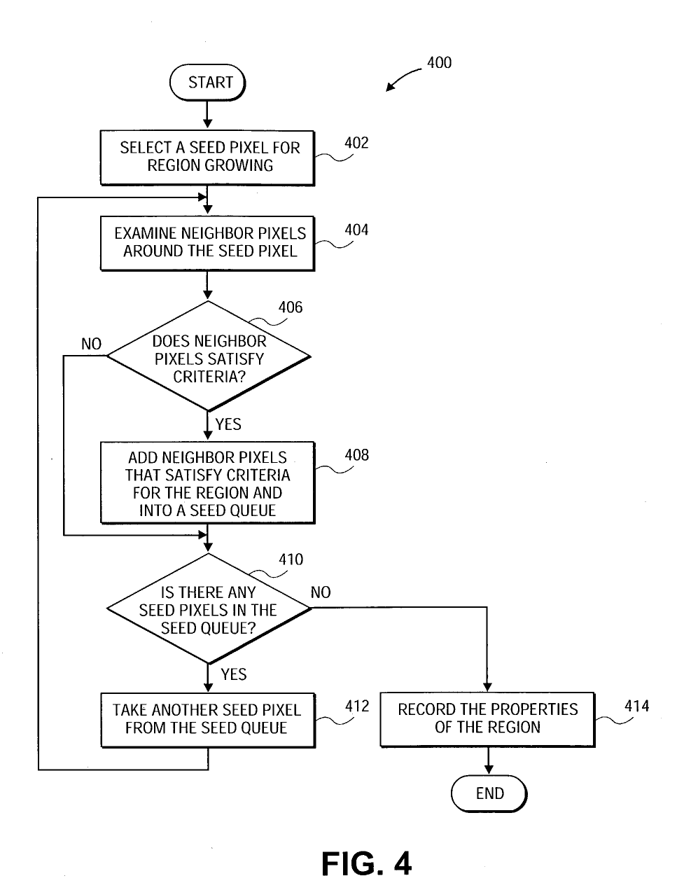

Next, a region within image 800 is selected to define object 801 for the golden template image (step 304). To define object 801, an interface, e.g., an interface showing image 800, can be provided to a user on a display, thereby allowing the user to input knowledge about object 801. For example, a user can select a region 803 for applying a region growing algorithm according to a specified criteria. This algorithm is described in further detail below regarding FIG. 4. The region growing algorithm uses a seed pixel within the selected region 803 to extract pixels from image 800 for inclusion as an object region in the golden template image associated with object 801. The selected region 803 can be a rectangle or any arbitrary shape. Features or feature vectors for selected region 803 can be extracted as (Vₘₑₐₙ, Vᵥₐᵣ), where Vₘₑₐₙ is the mean of the feature vector and Vᵥₐᵣ is the feature variance. These feature vectors can be used by the region growing algorithm to extract the object region for object 801.

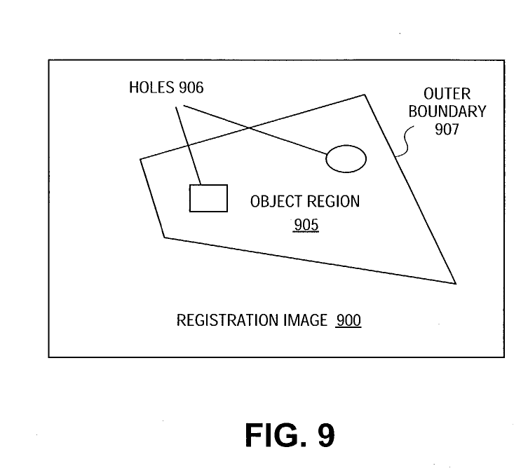

After selecting region 803, a region growing algorithm according to a specified criteria is applied to extract an object region for object 801 (step 306). For example, referring to FIG. 9, an object region 905 can be extracted from the region of image 800 for object 801.

In one implementation, if the distance between two feature vectors can be expressed as follows:

D(V₁, V₂)=∥V₁-V₂∥

the specified criteria for applying the region growing algorithm to extract the object region 905 can be expressed as follows:

$$Pixel = \{ \begin{matrix}region pixel , & if D ( {V}_{Pixel} , {V}_{mean} ) \leq {T}_{v} \\ none , & if D ( {V}_{Pixel} , {V}_{mean} ) > {T}_{v}\end{matrix}$$

where Vₚᵢₓₑₗ is the feature vector obtained on the pixel to be analyzed, and Tᵥ is the criteria threshold: Tᵥ=γ∥Vᵥₐᵣ∥. The parameter γ can be user selected to control the sensitivity for ignoring noise or other small flaws and defects. The features (Vₘₑₐₙ, Vᵥₐᵣ) for the selected region 803 can be extracted by selecting a region within image 800, or, alternatively, the individual values of the feature vectors can be specified by a user to determine (Vₘₑₐₙ, Vᵥₐᵣ). If only the properties of the object are defined with an appropriate feature vector (Vₘₑₐₙ, Vᵥₐᵣ) and the distance function D(V₁, V₂) is available, the region growing algorithm using the above specified criteria can be applied to extract object region 905.

For example, if a pixel to be analyzed satisfies the criteria of D(Vₚᵢₓₑₗ, V_{Mean})≦Tᵥ, then it can be identified as a “region pixel” and labeled accordingly. If the pixel satisfies the criteria D(V_{Pixel}, V_{Mean})>Tᵥ, then it is not a region pixel. Such a pixel can be identified or labeled as a “non-region pixel” or left alone. Each pixel within an object region can be analyzed. For the pixels identified as a “region pixel,” those pixels are extracted as part of object region 905. Extracted object region 905 can also be labeled with an ID and mapped into registration image 900 shown in FIG. 9.

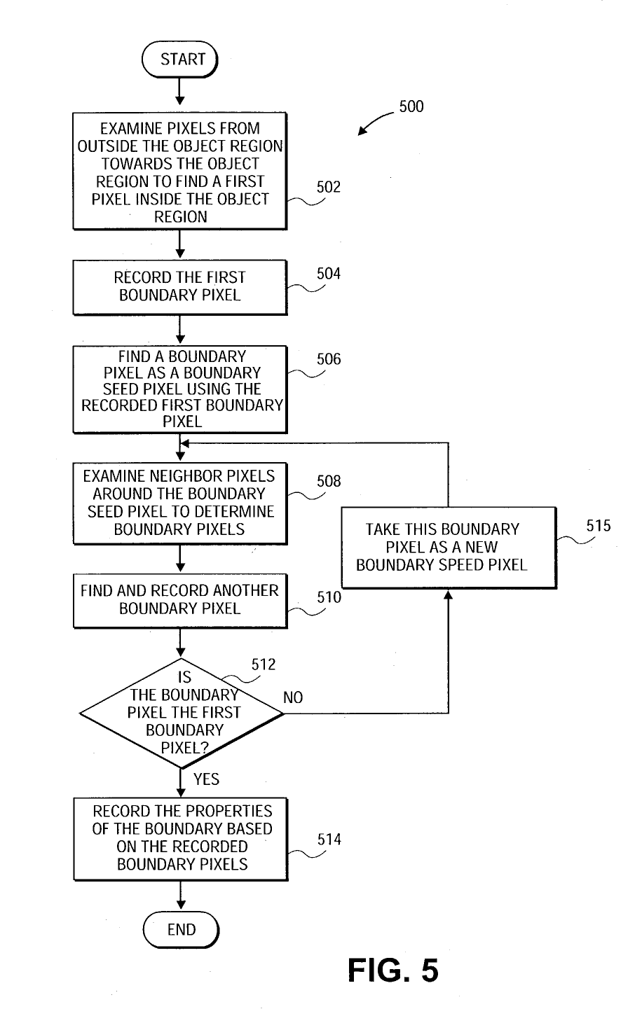

After object region 805 is extracted, a boundary tracing algorithm is applied according a specified criteria using extracted object region 805 to extract an outer boundary 907 (step 308). For example, referring to FIG. 9, outer boundary 907 can be extracted using the extracted object region 905 as described in further detail below regarding FIG. 5. In one implementation, the criteria for extracting outer boundary 907 can be expressed as follows:

$$Object Pixel = \{ \begin{matrix}boundary pixel , if a neighbor pixel does not belong to object region \\ not boundary pixel , if neighbor pixels all belong to object region\end{matrix}$$

where the “object pixel” can be a pixel identified as a “region pixel” in step 306. With the above criteria, object pixels can be analyzed to determine if it is a boundary pixel. For example, an object pixel having a neighbor pixel that does not belong to object region 905 satisfies the above criteria for a “boundary pixel.” Such a pixel can be identified or labeled as a “boundary pixel.” If the neighbor pixels all belong to object region 905, then the pixel satisfies the criteria that it is not a boundary pixel. In this case, the pixel and its neighbors are object region pixels. Each pixel within object region 905 can be analyzed for being a boundary pixel. For the pixels identified as a “boundary pixel,” those pixels are extracted as part of outer boundary 907 for object region 905. Extracted outer boundary 907 can also be labeled with an ID and mapped into registration image 900 of FIG. 9.

After outer boundary 907 is extracted, a region growing algorithm is applied according to a specified criteria using extracted object region 905 and outer boundary 907 to extract object 801 (FIG. 8) for the golden template image. This algorithm can extract the golden template image that ignores defects, e.g., holes 906, which can be present in image 900 as described in further detail regarding FIG. 6.

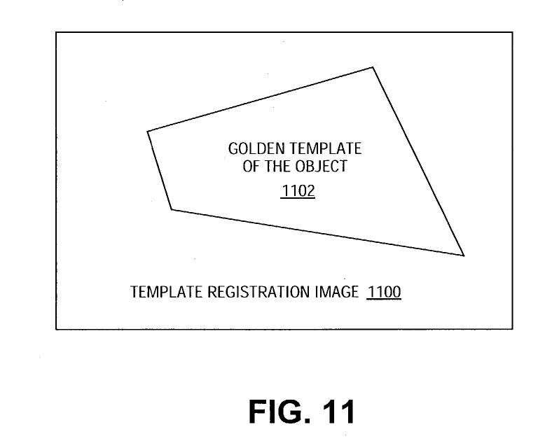

For example, referring to FIG. 11, a golden template of the object 1102 (“golden template 1102 ”) can be extracted using extracted object region 905 and outer boundary 907 of FIG. 9 that fills in holes 906 with region pixels. In one implementation, the criteria for extracting golden template 1102 can be expressed as follows:

$$Pixel = \{ \begin{matrix}region pixel , if not identified as an object pixel \\ none , if identified as an object pixel already\end{matrix}$$

where the “pixel” can be a pixel within outer boundary 907. With this criteria, pixels within outer boundary 907 can be analyzed to determine if it has been identified as an “object pixel” for object region 905. If an analyzed pixel within outer boundary 907 is not identified as an object pixel, it is a pixel in holes 906. For such a pixel, it then becomes identified as a “region pixel” for golden template 1102. In this manner, holes 906 can be ignored or filled in to become part of the object region for golden template 1102. Golden template 1102 can be stored in a template registration image 1100 shown in FIG. 11. Template registration image 1100 refers to an image for representing the golden template object regions.

FIG. 4 illustrates a detailed flow diagram of a method 400 for applying a region growing algorithm to extract an object region from an image of a sample unit such as image 800 for object 801. This algorithm can performed using registration image 900 of FIG. 9. Initially, a seed pixel is selected for region growing within region 803 (step 402). Any pixel in selected region 803 satisfying the specified criteria, e.g., as described in step 306 of FIG. 3, can be used as the seed pixel. Next, neighbor pixels around the seed pixel are examined (step 404). These pixels are determined if they satisfy the specified criteria as noted above. For example, n neighbor pixels (e.g., n=4) around the seed pixel can be examined to determine if they satisfy the criteria of D(V_{Pixel}, V_{Mean})≦Tᵥ for being a “region pixel.” If the pixels satisfy this criteria, they can be identified and labeled as region pixels. If neighbor pixels satisfy the criteria of D(V_{Pixel}, V_{Mean})>Tᵥ for not being a region pixel, these pixels can be identified and labeled as a “non-region pixel” or “none.” Each pixel in the region can be examined to determine if they satisfy the criteria. If there are no neighbor pixels that satisfy the specified criteria, the method 400 continues to step 410.

If there are neighbor pixels that satisfy the criteria, such pixels are added for object region 905 and into a seed queue (step 408). A decision is then made if there are any seed pixels in the seed queue (step 410). If there are seed pixels in the seed queue, another seed pixel is taken from the seed queue (step 412). The method 400 then continues back to step 404 for the new seed pixel (step 412). Thus, this process can be iterative until there are no more pixels to be examined or identified. If there are no more seed pixels in the seed queue, all of the pixels in the region have been examined and the properties of the region are recorded (step 414). For example, the properties recorded can be recording pixels identified as region pixels as part of object region 905 shown in FIG. 9.

FIG. 5 illustrates a detailed flow diagram of a method 500 for applying a boundary tracing algorithm according to a specified criteria to extract outer boundary 907 for object region 905. Initially, pixels are examined from outside of object region 905 towards object region 905 to find a first pixel inside object region 905 (step 502). For example, pixels are examined to determine if one of the pixels has been identified as an “object pixel” or “region pixel.” In such a case, the pixel is the first boundary pixel to be found in object region 905 and is then recorded (step 504). Next, a search is made to find the first boundary seed pixel, which is designated as the “boundary seed pixel,” using the recorded first boundary pixel in object region 905 (step 506). The above criteria for determining a boundary pixel can be used. For example, neighboring pixels around the recorded first pixel can be examined to determine if any of them are part of object region 905, and at least one of the four neighbor pixels of which does not belong to the object region 905. The first pixel that satisfies this criteria can be designated as the boundary seed pixel.

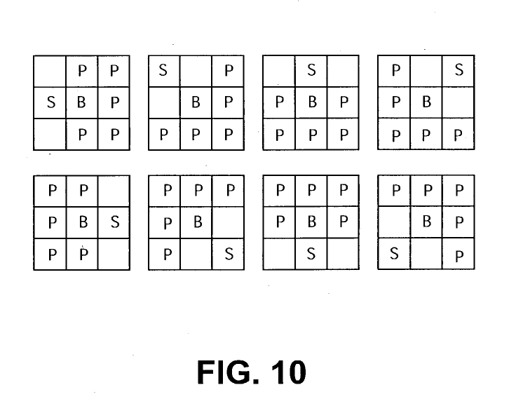

Next, the neighbor pixels around the boundary seed pixel are examined to determine if they are boundary pixels (step 508). This step can use the above boundary tracing criteria to trace an outer boundary of object region 905. For example, referring to the boundary tracing graph of FIG. 10, the tracing process can start at a pixel labeled “S” for a boundary seed pixel in which the neighboring pixels can be examined if they satisfy the criteria for being a boundary pixel. If so, the pixels can be identified as “B” for a new boundary pixel. If it cannot be determined the pixel is a boundary pixel, it can be identified as “P” for a possible boundary pixel. In one implementation, for every located boundary pixel B, the process can analyze n neighboring pixels (e.g., n=5) in a clockwise or counter clockwise manner. The first pixel satisfying the boundary tracing criteria will be taken as the new boundary pixel. Once the boundary tracing reaches the boundary seed pixel, the tracing process stops. A linked outer boundary 907 of object region 905 can then be obtained.

For each boundary pixel that is found, it is recorded for outer boundary 907 of object region 905 (step 510). A decision is then made to determine if the boundary pixel is the first boundary pixel recorded (step 512). If it is not the first boundary pixel, then it can be determined that not all of the boundary pixels have been found, and the boundary pixel found is taken as a new boundary seed pixel (step 515). The process then returns to step 508. If it is the first boundary pixel, the properties of the boundary are recorded based on the recorded boundary pixels (step 514). These properties can include the identification of each of the boundary pixels within extracted outer boundary 907.

FIG. 6 illustrates a detailed flow diagram of a method 600 for applying a region growing algorithm according to a specified criteria using extracted object region 905 and outer boundary 907 to extract golden template image 1102. Initially, referring back to FIG. 9, outer boundary 907 is labeled within registration image 900 (step 602). The outer boundary 907 can be labeled with a unique ID. Next, a seed pixel within object region 905 is chosen (step 604). Preferably, the chosen seed pixel is within object region 905 and not on outer boundary 907. Object region 905 is flooded (or labeling all the pixels within the regions) using a region growing algorithm according to a specified criteria bounded by outer boundary 907 (step 606). For example, using the above noted criteria, each pixel within object region 905 is examined to determine if the pixel is identified as an object pixel or region pixel within object region 905. Alternatively, each pixel can be examined if it is within boundary 907 to determine that it is in object region 905.

Each pixel within boundary 907 becomes identified or labeled as an object pixel or region pixel. That is, each pixel not identified or labeled within outer boundary 907 is converted to an identified pixel as part of an extracted object region for golden template 1102. In this manner, pixels associated with holes 906, which are within boundary 907 and not identified as an object pixel or region pixel, are designated as object pixels or region pixels for golden template 1102. Thus, holes 906 are filled in for golden template image 1102. After applying the region growing algorithm, the golden template region of the object 1102 is obtained (step 608). For this step, the pixels identified as being object pixels or region pixels are stored in the golden template image 1102 associated with object region 905 and outer boundary 907.

FIG. 7 illustrates a flow diagram of a method 700 for computing rotational template images for the extracted golden template image 1102. An array of rotational template images is normally required at a certain interval (e.g. 1 degree) due to the presence of rotation of testing units. The range of rotation can be from −10 degrees of rotation to +10 degrees of rotation. The rotation templates can be pre-computed and stored in storage 50 along with golden template images or registration images to avoid computing the template images during inspection.

Initially, the outer boundary of the golden template 1102 is rotated. For example, If P_{T} is a point on the original object template, the new template rotated by θ can be computed as follows:

$$\{ \begin{matrix}{P}_{R *} x = {P}_{T *} x * cos ( θ ) - {P}_{T *} y * sin ( θ ) \\ {P}_{R *} y = {P}_{T *} x * sin ( θ ) + {P}_{T *} y * cos ( θ )\end{matrix}$$

Next, the outer boundary is interpolated after rotation as a result of some pixels being missing on the rotated template because of the discrete image pixel difference along different directions (step 704). In particular, because the linked outer boundary of the object is rotated by θ, some breaking points will also be created due to the rotation effect and a interpolation is required at the breaking points on the boundary. This interpolation is explained with respect to two adjacent points P_{B}[i] and P_{B}[i+1] on the outer boundary. If, for example, |P_{B}[i]x−P_{B}[i+1]x|>1, one boundary point should be interpolated between, P_{B}[i] and P_{B}[i+1], then the following applies:

$$\{ \begin{matrix}{P}_{B} [ i ] x = \frac{( {P}_{B} [ i ] x + {P}_{B} [ i ] x )}{2} \\ {P}_{B} [ i ] y = {P}_{B} [ i ] y\end{matrix}$$

Otherwise, if |P_{B}[i]y−P_{B}[i+1]y|>1, one boundary point should be interpolated between P_{B}[i] and P_{B}[i+1] as follows:

$$\{ \begin{matrix}{P}_{B} [ i ] y = \frac{( {P}_{B} [ i ] y + {P}_{B} [ i ] y )}{2} \\ {P}_{B} [ i ] x = {P}_{B} [ i ] y\end{matrix}$$

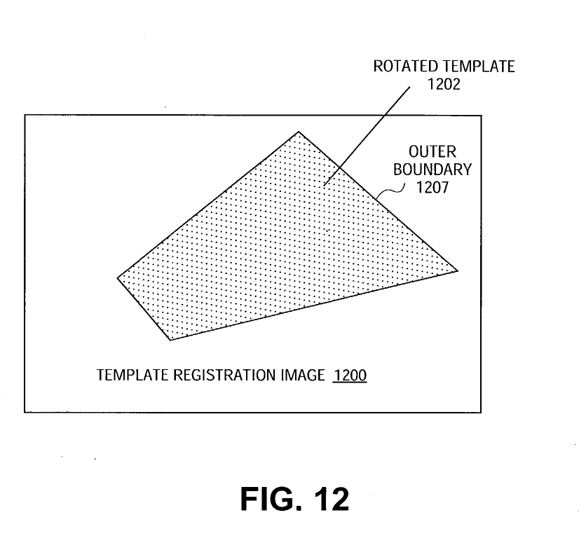

After interpolation, a complete outer boundary 1207 of the rotated template can be obtained and labeled on the template registration image 1200 (step 706). To recover the rotated template shown in FIG. 12, another region growing algorithm is applied for the rotated template, which requires finding a seed pixel within the boundary 1207 (step 708). The seed pixel can be located by taking a pixel on the rotated template that is not on the rotated outer boundary 1207.

Next, the region bounded by outer boundary 1207 is flooded using a region growing algorithm according to a specified criteria and the seed pixel (step 710). For example, neighboring pixels around the seed pixel are examined to determine if the pixel is within the boundary 1207. For each examined pixel within the boundary 907, it is identified as an object pixel or region pixel for the rotated template. With this step, all the pixels within the boundary 1207 are flooded as being an object pixel or region pixel. After applying the region growing algorithm, the rotated template is recorded (step 712). This can include storing the identifier information related to the pixels within the boundary 1207.

Thus, a method and system for extracting a golden template using a non-golden sample unit have been described. Furthermore, while there has been illustrated and described what are at present considered to be exemplary embodiments of the present invention, various changes and modifications can be made, and equivalents can be substituted for elements thereof, without departing from the true scope of the invention. In particular, modifications can be made to adapt a particular element, technique, or implementation to the teachings of the present invention without departing from the spirit of the invention.

What is claimed is:

1. A method for extracting a golden template image of a unit, comprising:
obtaining an image associated with the unit;
selecting a region within the image;
applying a first region growing algorithm to extract an object region using the selected region;
applying a boundary tracing algorithm to extract an outer boundary of the object region using the extracted object region; and
applying a second region growing algorithm to extract a golden template image of the unit using the extracted object region and outer boundary.

2. The method of claim 1, further comprising:
computing one or more rotational template images of the extracted golden template image.

3. The method of claim 2, wherein computing the one or more rotational template images includes:
rotating the extracted golden template image;
interpolating the outer boundary of the rotated golden template image;
selecting a seed pixel within the rotated outer boundary; and
identifying the pixels around the seed pixel as a region pixel for the rotated template image.

4. The method of claim 1, wherein applying the first region growing algorithm includes:
selecting a seed pixel within the selected region;
examining pixels around the seed pixel to determine if the pixels satisfy the first criteria; and
recording the pixels that satisfy the first criteria.

5. The method of claim 1, wherein applying the boundary tracing algorithm includes:
locating a boundary seed pixel within the extracted object region;
examining pixels around the boundary seed pixel to determine if the pixels satisfy the second criteria; and
recording the pixels that satisfy the second criteria.

6. The method of claim 1, wherein applying the second region growing algorithm includes:
selecting a seed pixel within the extracted outer boundary; and
identifying the pixels around the seed pixel as a region pixel for the golden template image.

7. The method of claim 1, wherein the unit is a non-golden sample unit or a golden sample unit.

8. An image processing system for extracting a golden template image of a unit, comprising:
an imaging device to obtain an image associated with the unit; and
a processor coupled to the imaging device, the processor extracting an object region and outer boundary of the object region from the image, and extracting a golden template image using the extracted object region and outer boundary that accommodates for defects in the obtained image.

9. The image processing system of claim 8, wherein the unit is a non-golden sample unit or a golden sample unit.

10. The image processing system of claim 8, wherein the processor computes one or more rotational template images of the extracted golden template image.

11. The image processing system of claim 10, further comprising:
a storage device to store at least one of the extracted golden template image and rotational template images.

12. The image processing system of claim 8, wherein the processor extracts the object region using a region growing algorithm according to a first criteria.

13. The image processing system of claim 8, wherein the processor extracts the outer boundary using a boundary tracing algorithm according to a second criteria.

14. The image processing system of claim 8, wherein the processor extracts the golden template image using a region growing algorithm according to a third criteria.

15. The image processing system of claim 13, wherein the processor applies the region growing algorithm according to the third criteria by identifying pixels around a seed pixel within the extracted outer boundary as a region pixel for the golden template image.

16. A computer-readable medium containing instructions which, when executed by a processing system, cause the processing system to perform a method comprising:
obtaining an image associated with the unit;
selecting a region within the image;
applying a first region growing algorithm to extract an object region using the selected region;
applying a boundary tracing algorithm to extract an outer boundary of the object region using the extracted object region; and
applying a second region growing algorithm to extract a golden template image of the unit using the extracted object region and outer boundary.

17. The computer-readable medium of claim 16, wherein the instructions, when executed by the processing system, cause the processing system to perform a further step of:
computing one or more rotational template images of the extracted golden template image.

18. The computer-readable medium of claim 16, wherein the instructions, when executed by the processing system, cause the processing system to perform further steps of:
selecting a seed pixel within the selected region;
examining pixels around the seed pixel to determine if the pixels satisfy the first criteria; and
recording the pixels that satisfy the first criteria.

19. The computer-readable medium of claim 16, wherein the instructions, when executed by the processing system, cause the processing system to perform further steps of:
finding a boundary seed pixel within the extracted object region;
examining pixels around the boundary seed pixel to determine if the pixels satisfy the second criteria; and
recording the pixels that satisfy the second criteria.

20. The computer-readable medium of claim 16, wherein the instructions, when executed by the processing system, cause the processing system to perform further steps of:
selecting a seed pixel within the extracted outer boundary; and
identifying the pixels around the seed pixel as a region pixel for the golden template image.
